(19) United States
(12) Patent Application Publication
(10) Pub. No.: US 2025/0336390 A1
(43) Pub. Date: Oct. 30, 2025

(54) DEVICE AND METHOD FOR UPDATING A DIGITAL-ASSISTANT RECOMMENDATION IN RESPONSE TO A USER NOT FOLLOWING THE RECOMMENDATION

(71) Applicant: MOTOROLA SOLUTIONS, INC., CHICAGO, IL (US)

(72) Inventors: HUI BOON CHUA, BATU PAHAT (MY); SYED ISA SYED IDRUS, BAYAN LEPAS (MY); BALAMURUGAN MURUGAMUDALI THANIKACHALAM, GEORGETOWN (MY); KHAIRUL AZHAR ABU BAKAR, KEPALA BATAS (MY)

(21) Appl. No.: 18/645,784

(22) Filed: Apr. 25, 2024

(51) Int. Cl. G10L 13/027; G06V 20/00; G06V 20/40; G06V 40/20

(52) U.S. Cl. CPC G10L 13/027; G06V 20/35; G06V 20/44; G06V 40/23

(57) ABSTRACT

A process of updating a digital-assistant recommendation in response to a user not following the recommendation. In operation, an electronic computing device generates and provides a digital-assistant recommendation for a user based on contextual data currently available corresponding to the user and responsively monitors whether the user is following the recommendation. If it is determined that the user is not following the recommendation, the electronic computing device further determines whether there is a correlation between the user not following the recommendation and change in contextual data currently available corresponding to the user. If there is a correlation between the user not following the recommendation and the change in the contextual data currently available corresponding to the user, the electronic computing device generates and provides an updated digital-assistant recommendation for the user based at least in part on the change in the contextual data currently available corresponding to the user.

### BACKGROUND

Tablets, laptops, phones (for example, cellular or satellite), mobile (vehicular) or portable (personal) two-way radios, and other communication devices are now in common use by users, such as first responders (including firemen, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such communication devices further comprise, or provide access to, electronic digital assistants (or sometimes referenced as “virtual partners”) that may provide the user thereof with valuable information in an automated (for example, without further user input) or semi-automated (for example, with some further user input) fashion. The valuable information provided to the user may be based on explicit requests for such information posed by the user via an input (for example, such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as ViQi provided by Motorola Solutions, Inc.®, Siri provided by Apple, Inc.®, and Google Now provided by Google, Inc.®, are software applications running on underlying electronic hardware that are capable of understanding natural language, and may complete electronic tasks in response to user voice inputs, among other additional or alternative types of inputs. Some of these electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, warning users of nearby dangers such as traffic accidents or environmental hazards, and providing many other types of information in a reactive or proactive manner.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a system diagram illustrating a system for operating an electronic digital assistant, in accordance with some embodiments.

FIG. 2 is a device diagram showing a device structure of a communication device of FIG. 1 in accordance with some embodiments.

FIG. 3 illustrates a flowchart of a process for updating a digital-assistant recommendation in response to a user not following the recommendation.

FIG. 4 illustrates a first example scenario in which the embodiments described herein can be advantageously implemented to update a digital-assistant recommendation in response to a user not following the recommendation.

FIG. 5 illustrates a second example scenario in which the embodiments described herein can be advantageously implemented to update a digital-assistant recommendation in response to a user not following the recommendation.

FIG. 6 illustrates a third example scenario in which the embodiments described herein can be advantageously implemented to update a digital-assistant recommendation in response to a user not following the recommendation.

FIG. 7 illustrates a fourth example scenario in which the embodiments described herein can be advantageously implemented to update a digital-assistant recommendation in response to a user not following the recommendation.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As described above, communication devices often comprise, or provide access to, electronic digital assistants (sometimes referenced as “virtual partners” or “virtual assistants”). Electronic digital assistants, proactively or in response to a query from a user, provide users with recommendations for tasks performed by users based on data available to the assistants immediately prior to generating the recommendations. In some situations, recommendations provided by a digital assistant may become outdated and unreliable by the time the user begins to execute the task in accordance with the recommendations provided by the digital assistant.

Assume a firefighter is assigned to respond to a fire incident at a building and a digital assistant has been deployed to aid the firefighter with responding to the fire incident. The digital assistant may generate recommendations for the firefighter based on the current environmental conditions associated with the firefighter. For example, assume the digital assistant provides recommendations to the firefighter to spray water in a particular direction towards the building to control and extinguish fires at the building. However, as the fire fighter begins to spray water in the direction recommended by the digital assistant, the firefighter sees a severe wind blowing against the direction recommended by the virtual assistant. The firefighter may hesitate to follow the direction recommended by the digital assistant because the firefighter would not know if the digital assistant considered the intensity of wind or the direction of wind before recommending a direction for spraying water. In such situations, users may question the accuracy and reliability of recommendations provided by digital assistants and may instead perform a different action that does not follow the digital-assistant recommendations.

While digital assistants can be configured to, either periodically or in response to additional user queries, update recommendations provided to users by considering user's updated contextual situation, a problem still exists in that digital assistants do not proactively monitor user's action or inaction subsequent to providing the recommendations to determine if the user is following or not following the recommendations. Another problem is that digital assistants require a user to submit additional queries or user input describing the user's updated contextual situation or the user's hesitation in not following the recommendation before the digital assistants can provide updated recommendations to the user. It may be however inconvenient or even dangerous for some users such as first responders to continuously interact with virtual assistants while performing a task such as responding to an incident in order to receive updated recommendations each time there is a substantial change in user's contextual situation.

Therefore, a need exists for a technological solution that enables electronic digital assistants to proactively determine a correlation between a user not following a recommendation provided by a digital assistant and a change in contextual data currently available corresponding to the user and further provide an updated recommendation to the user based on the change in contextual data currently available corresponding to the user.

One embodiment provides a method of updating a digital-assistant recommendation in response to a user not following the recommendation. The method comprises: generating, at an electronic computing device, a digital-assistant recommendation for a user based on contextual data currently available corresponding to the user; providing, at the electronic computing device, via a visual and/or audio output device associated with the user, a first visual and/or audio output including the digital-assistant recommendation, and responsively monitoring whether the user is following the digital-assistant recommendation; responsive to determining that the user is not following the recommendation, determining, at the electronic computing device, that there has been a change in the contextual data currently available corresponding to the user since generating the digital-assistant recommendation; determining, at the electronic computing device, whether there is a correlation between the user not following the recommendation and the change in the contextual data currently available corresponding to the user; responsive to determining that there is the correlation between the user not following the recommendation and the change in the contextual data currently available corresponding to the user, generating, at the electronic computing device, an updated digital-assistant recommendation for the user based at least in part on the change in the contextual data currently available corresponding to the user; and providing, at the electronic computing device, via the visual and/or audio output device associated with the user, a second visual and/or audio output including the updated digital-assistant recommendation.

Another embodiment provides an electronic computing device, comprising: an electronic processor; and a visual and/or audio output device communicatively coupled to the electronic processor. The electronic processor is configured to: generate a digital-assistant recommendation for a user based on contextual data currently available corresponding to the user; provide, via the visual and/or audio output device associated with the user, a first visual and/or audio output including the digital-assistant recommendation, and responsively monitor whether the user is following the digital-assistant recommendation; responsive to determining that the user is not following the recommendation, determine that there has been a change in the contextual data currently available corresponding to the user since generating the digital-assistant recommendation; determine whether there is a correlation between the user not following the recommendation and the change in the contextual data currently available corresponding to the user; responsive to determining that there is the correlation between the user not following the recommendation and the change in the contextual data currently available corresponding to the user, generate an updated digital-assistant recommendation for the user based at least in part on the change in the contextual data currently available corresponding to the user; and provide, via the visual and/or audio output device associated with the user, a second visual and/or audio output including the updated digital-assistant recommendation.

Each of the above-mentioned embodiments will be discussed in more detail below, starting with example system and device architectures of the system in which the embodiments may be practiced, followed by an illustration of processing blocks for achieving an improved technical process of updating a digital-assistant recommendation in response to a user not following the recommendation. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

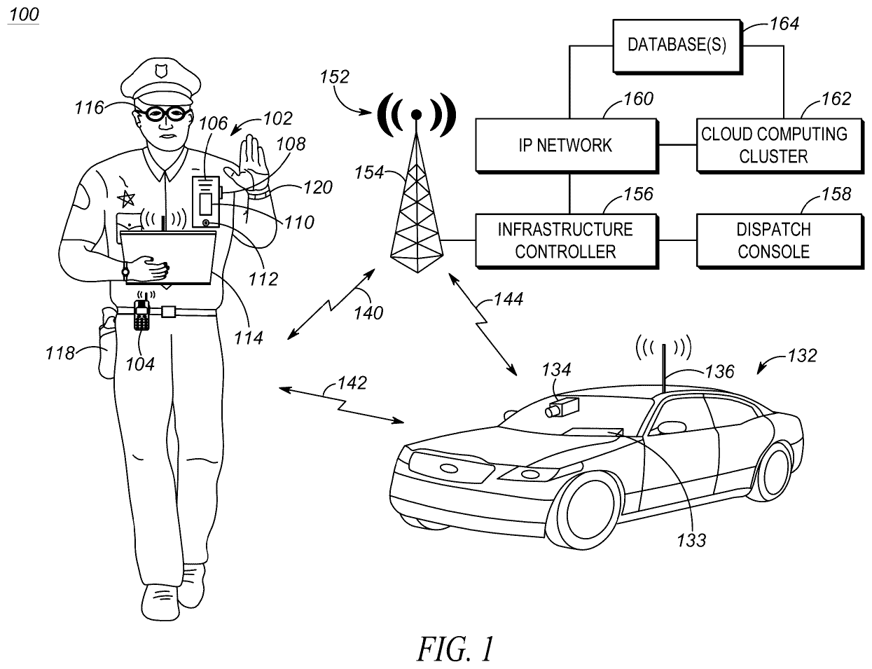

Referring now to the drawings, and in particular FIG. 1, a communication system 100 is shown including a first set of devices that a user 102 (illustrated in FIG. 1 as a first responder police officer) may wear, such as a primary battery-powered portable radio 104 used for narrowband and/or broadband direct-mode or infrastructure communications, a battery-powered radio speaker microphone (RSM) video capture device 106, a laptop 114 having an integrated video camera and used for data applications such as incident support applications, smart glasses 116 (for example, which may be virtual reality, augmented reality, or mixed reality glasses), sensor-enabled holster 118, and/or biometric sensor wristband 120. Although FIG. 1 illustrates only a single user 102 with a respective first set of devices, in other embodiments, the single user 102 may include additional sets of same or similar devices, and additional users may be present with respective additional sets of same or similar devices.

System 100 may also include a vehicle 132 associated with the user 102 having an integrated mobile communication device 133, an associated vehicular video camera 134, and a coupled vehicular transceiver 136. Although FIG. 1 illustrates only a single vehicle 132 with a single mobile communication device 133, respective single vehicular video camera 134 and/or microphone, and a single coupled vehicular transceiver 136, in other embodiments, the vehicle 132 may include additional same or similar mobile communication devices, video cameras, microphones, and/or transceivers, and additional vehicles may be present with respective additional sets of mobile communication devices, video cameras, microphones, and/or transceivers.

Each of the portable radio 104, RSM video capture device 106, laptop 114, and vehicular mobile communication device 133 may be capable of directly wirelessly communicating via direct-mode wireless link(s) 142, and/or may be capable of wirelessly communicating via a wireless infrastructure radio access network (RAN) 152 over respective wireless link(s) 140, 144 and via corresponding transceiver circuits. These devices are configured to receive inputs associated with the user 102 and/or provide outputs to the user 102 in addition to communicating information to and from other communication devices and the infrastructure RAN 152.

Many of the devices shown in FIG. 1 (such as the portable radio 104, the RSM video capture device 106, the laptop 114, the mobile communication device 133, the infrastructure controller 156, dispatch console 158, and one or more computing devices in the cloud computing cluster 162) may be referred to as communication devices. Although FIG. 1 shows multiple communication devices associated with the user 102, in some embodiments, the communication system 100 includes communication devices of multiple users. Further, the communication devices may form a talk group. In some embodiments, the communication devices communicate with each other over the infrastructure RAN 152 and/or communicate with each other directly as described herein. Similarly, other devices, such as the dispatch console 158, may communicate with communication devices of multiple users through the infrastructure RAN 152. In some embodiments, one or more users may have multiple associated communication devices, for example, as shown in FIG. 1.

The portable radio 104, in particular, may be any communication device 200 used for infrastructure RAN or direct-mode media (for example, voice, audio, video, etc.) communication via a long-range wireless transmitter and/or transceiver that has a transmitter transmit range on the order of miles, for example, 0.5-50 miles, or 3-20 miles (for example, in comparison to a short-range transmitter such as a Bluetooth, Zigbee, or NFC transmitter) with other communication devices and/or the infrastructure RAN 152. The long-range transmitter may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VOIP), an LTE Direct or LTE Device to Device, or a PTT over IP (PoIP) application may be implemented. In still further embodiments, the long range transmitter may implement a Wi-Fi protocol perhaps in accordance with an IEEE 802.11 standard (for example, 802.11a, 802.11b, 802.11g) or a WiMAX protocol perhaps operating in accordance with an IEEE 802.16 standard.

In the example of FIG. 1, the portable radio 104 may form the hub of communication connectivity for the user 102, through which other accessory devices, such as a biometric sensor (for example, the biometric sensor wristband 120), an activity tracker, a weapon status sensor (for example, the sensor-enabled holster 118), a heads-up-display (for example, the smart glasses 116), the RSM video capture device 106, and/or the laptop 114 may communicatively couple.

In order to communicate with and exchange video, audio, and other media and communications with the RSM video capture device 106, laptop 114, and/or smart glasses 116, the portable radio 104 may contain one or more physical electronic ports (such as a universal serial bus (USB) port, an Ethernet port, an audio jack, etc.) for direct electronic coupling with the RSM video capture device 106, laptop 114, and/or smart glasses 116. In some embodiments, the portable radio 104 may contain a short-range transmitter (for example, in comparison to the long-range transmitter such as a LMR or Broadband transmitter) and/or transceiver for wirelessly coupling with the RSM video capture device 106, laptop 114, and/or smart glasses 116. The short-range transmitter may be a Bluetooth, Zigbee, or near field communication (NFC) transmitter having a transmit range on the order of 0.01-100 meters, or 0.1-10 meters. In other embodiments, the RSM video capture device 106, the laptop 114, and/or the smart glasses 116 may contain their own long-range transceivers and may communicate with one another and/or with the infrastructure RAN 152 or vehicular transceiver 136 directly without passing through portable radio 104.

The RSM video capture device 106 provides voice functionality features similar to a traditional RSM, including one or more of acting as a remote microphone that is closer to the user's 102 mouth, providing a remote speaker allowing playback of audio closer to the user's 102 car, and including a PTT switch/interface or other type of PTT input. The voice and/or audio recorded at the remote microphone may be provided to the portable radio 104 for storage and/or analysis or for further transmission to other mobile communication devices or the infrastructure RAN 152, or may be directly transmitted by the RSM video capture device 106 to other communication devices or to the infrastructure RAN 152. The voice and/or audio played back at the remote speaker may be received from the portable radio 104 or received directly from one or more other communication devices or the infrastructure RAN 152. The RSM video capture device 106 may include a separate physical PTT switch 108 that functions, in cooperation with the portable radio 104 or on its own, to maintain the portable radio 104 and/or RSM video capture device 106 in a monitor only mode, and which switches the device(s) to a transmit-only mode (for half-duplex devices) or transmit and receive mode (for full-duplex devices) upon depression or activation of the PTT switch 108. The portable radio 104 and/or RSM video capture device 106 may form part of a group communications architecture such as a talk group that allows a single communication device to communicate with one or more group members (not shown) associated with a particular group of devices at a same time.

Additional features may be provided at the RSM video capture device 106 as well. For example, a display screen 110 may be provided for displaying images, video, and/or text to the user 102 or to someone else. The display screen 110 may be, for example, a liquid crystal display (LCD) screen or an organic light emitting display (OLED) display screen. In some embodiments, a touch sensitive input interface may be incorporated into the display screen 110 as well, allowing the user 102 to interact with content provided on the display screen 110. A soft PTT input may also be provided, for example, via such a touch interface.

A video camera 112 may also be provided at the RSM video capture device 106, integrating an ability to capture images and/or video and store the captured image data (for further analysis) or transmit the captured image data as an image or video stream to the portable radio 104 and/or to other communication devices or to the infrastructure RAN 152 directly. The video camera 112 and RSM remote microphone may be used, for example, for capturing audio and/or video of a field-of-view associated with the user 102, perhaps including a suspect and the suspect's surroundings, storing the captured image and/or audio data for further analysis or transmitting the captured audio and/or video data as an audio and/or video stream to the portable radio 104 and/or to other communication devices or to the infrastructure RAN 152 directly for further analysis. An RSM remote microphone of the RSM video capture device 106 may be an omni-directional or unidirectional microphone or array of omni-directional or unidirectional microphones that may be capable of identifying a direction from which a captured sound emanated.

In some embodiments, the RSM video capture device 106 may be replaced with a more limited body worn camera that may include the video camera 112 and/or microphone noted above for capturing audio and/or video, but may forego one or more of the features noted above that transform the body worn camera into a more full featured RSM, such as the separate physical PTT switch 108 and the display screen 110, and remote microphone functionality for voice communications in cooperation with portable radio 104. In some embodiments, the system 100 may additionally or alternatively include a fixed surveillance camera or a drone camera for monitoring the user 102 and/or the user surroundings.

The laptop 114, in particular, may be any wireless communication device used for infrastructure RAN or direct-mode media communication via a long-range or short-range wireless transmitter with other communication devices and/or the infrastructure RAN 152. The laptop 114 includes a display screen for displaying a user interface to an operating system and one or more applications running on the operating system, such as a broadband PTT communications application, a web browser application, a vehicle history database application, a workflow application, a forms or reporting tool application, an arrest record database application, an outstanding warrant database application, a mapping and/or navigation application, a health information database application, and/or other types of applications that may require user interaction to operate. The laptop 114 display screen may be, for example, an LCD screen or an OLED display screen. In some embodiments, a touch sensitive input interface may be incorporated into the display screen as well, allowing the user 102 to interact with content provided on the display screen. A soft PTT input may also be provided, for example, via such a touch interface.

Front and/or rear-facing video cameras may also be provided at the laptop 114, integrating an ability to capture video and/or audio of the user 102 and the user's 102 surroundings, perhaps including a field-of-view of the user 102 and/or a suspect (or potential suspect) and the suspect's surroundings, and store and/or otherwise process the captured video and/or audio for further analysis or transmit the captured video and/or audio as a video and/or audio stream to the portable radio 104, other communication devices, and/or the infrastructure RAN 152 for further analysis.

The smart glasses 116 may include a digital imaging device, an electronic processor, a short-range and/or long-range transceiver device, and/or a projecting device. The smart glasses 116 may maintain a bi-directional connection with the portable radio 104 and provide an always-on or on-demand video feed pointed in a direction of the user's 102 gaze via the digital imaging device, and/or may provide a personal display via the projection device integrated into the smart glasses 116 for displaying information such as text, images, or video received from the portable radio 104 or directly from the infrastructure RAN 152. In some embodiments, the smart glasses 116 may include its own long-range transceiver and may communicate with other communication devices and/or with the infrastructure RAN 152 or vehicular transceiver 136 directly without passing through portable radio 104. In some embodiments, an additional user interface mechanism such as a touch interface or gesture detection mechanism may be provided at the smart glasses 116 that allows the user 102 to interact with the display elements displayed on the smart glasses 116 or projected into the eyes of the user 102, or to modify operation of the digital imaging device. In other embodiments, a display and input interface at the portable radio 104 may be provided for interacting with smart glasses 116 content and modifying operation of the digital imaging device, among other possibilities.

The smart glasses 116 may provide a virtual reality interface in which a computer-simulated reality electronically replicates an environment with which the user 102 may interact. In some embodiments, the smart glasses 116 may provide an augmented reality interface in which a direct or indirect view of real-world environments in which the user is currently disposed are augmented (that is, supplemented, by additional computer-generated sensory input such as sound, video, images, graphics, GPS data, or other information). In still other embodiments, the smart glasses 116 may provide a mixed reality interface in which electronically generated objects are inserted in a direct or indirect view of real-world environments in a manner such that they may co-exist and interact in real time with the real-world environment and real world objects.

The sensor-enabled holster 118 may be an active (powered) or passive (non-powered) sensor that maintains and/or provides state information regarding a weapon or other item normally disposed within the sensor-enabled holster 118 of the user 102. The sensor-enabled holster 118 may detect a change in state (presence to absence) and/or an action (removal) relative to the weapon normally disposed within the sensor-enabled holster 118. The detected change in state and/or action may be reported to the portable radio 104 via its short-range transceiver. In some embodiments, the sensor-enabled holster 118 may also detect whether the first responder's hand is resting on the weapon even if it has not yet been removed from the holster and provide such information to portable radio 104. In some embodiments, a weapon of the user 102 may include a sensor that detects when the weapon is discharged. The detected discharge may be reported to the portable radio 104, for example. Other possibilities exist as well.

The biometric sensor wristband 120 may be an electronic device for tracking an activity of the user 102 or a health status of the user 102, and may include one or more movement sensors (such as an accelerometer, magnetometer, and/or gyroscope) that may periodically or intermittently provide to the portable radio 104 indications of orientation, direction, steps, acceleration, and/or speed, and indications of health such as one or more of a captured heart rate, a captured breathing rate, and a captured body temperature of the user 102, perhaps accompanying other information. In some embodiments, the biometric sensor wristband 120 may include its own long-range transceiver and may communicate with other communication devices and/or with the infrastructure RAN 152 or vehicular transceiver 136 directly without passing through portable radio 104.

An accelerometer is a device that measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

The heart rate sensor may use electrical contacts with the skin to monitor an electrocardiogramaignal of its wearer, or may use infrared light and imaging device to optically detect a pulse rate of its wearer, among other possibilities.

A breathing rate sensor may be integrated within the sensor wristband 120 itself, or disposed separately and communicate with the sensor wristband 120 via a short range wireless or wired connection. The breathing rate sensor may include use of differential capacitive circuits or capacitive transducers to measure chest displacement and thus breathing rates. In other embodiments, a breathing sensor may monitor a periodicity of mouth and/or nose-exhaled air (for example, using a humidity sensor, temperature sensor, capnometer or spirometer) to detect a respiration rate. Other possibilities exist as well.

A body temperature sensor may include an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities.

Although the biometric sensor wristband 120 is shown in FIG. 1 as a bracelet worn around the wrist, in other examples, the biometric sensor wristband 120 may additionally and/or alternatively be worn around another part of the body, or may take a different physical form including an earring, a finger ring, a necklace, a glove, a belt, or some other type of wearable, ingestible, or insertable form factor. In some embodiments, the biometric sensor wristband 120 or another device of the user 102 may detect characteristics of the environment of the user 102 (for example, temperature, humidity, air quality, wind direction, and the like).

The portable radio 104, RSM video capture device 106, laptop 114, smart glasses 116, sensor-enabled holster 118, and/or biometric sensor wristband 120 may form a personal area network (PAN) via corresponding short-range PAN transceivers, which may be based on a Bluetooth, Zigbee, Bluetooth Low Energy, WiFi, Near Field Communication (NFC), Radio Frequency ID (RFID) or other short-range wireless protocol having a transmission range on the order of meters, tens of meters, or hundreds of meters.

The portable radio 104 and/or RSM video capture device 106 (or any other device in FIG. 1, for that matter) may each include a location determination device integrated with or separately disposed in the portable radio 104 and/or RSM 106 and/or in respective receivers, transmitters, or transceivers of the portable radio 104 and RSM 106 for determining a location of the portable radio 104 and RSM 106. The location determination device may be, for example, a global positioning system (GPS) receiver or wireless triangulation logic using a wireless receiver or transceiver and a plurality of wireless signals received at the wireless receiver or transceiver from different locations, among other possibilities. The location determination device may also include an orientation sensor for determining an orientation that the device is facing. Each orientation sensor may include a gyroscope and/or a magnetometer. Other types of orientation sensors could be used as well. The location may then be stored locally or transmitted via the transmitter or transceiver to other communication devices and/or to the infrastructure RAN 152.

The vehicle 132 associated with the user 102 may include the mobile communication device 133, the vehicular video camera 134 and/or microphone, and the vehicular transceiver 136, all of which may be coupled to one another via a wired and/or wireless vehicle area network (VAN), perhaps along with other sensors physically or communicatively coupled to the vehicle 132. The vehicular transceiver 136 may include a long-range transceiver for directly wirelessly communicating with communication devices such as the portable radio 104, the RSM 106, and the laptop 114 via wireless link(s) 142 and/or for wirelessly communicating with the RAN 152 via wireless link(s) 144. The vehicular transceiver 136 may further include a short-range wireless transceiver or wired transceiver for communicatively coupling between the mobile communication device 133 and/or the vehicular video camera 134 in the VAN. The mobile communication device 133 may, in some embodiments, include the vehicular transceiver 136 and/or the vehicular video camera 134 integrated therewith, and may operate to store and/or process video and/or audio produced by the video camera 134 and/or transmit the captured video and/or audio as a video and/or audio stream to the portable radio 104, other communication devices, and/or the infrastructure RAN 152 for further analysis. An omni-directional or unidirectional microphone (not shown), or an array thereof, may be integrated in the video camera 134 and/or at the mobile communication device 133 (or additionally or alternatively made available at a separate location of the vehicle 132) and communicatively coupled to the mobile communication device 133 and/or vehicular transceiver 136 for capturing audio and storing, processing, and/or transmitting the audio in a same or similar manner to the video as set forth above. The omni-directional or unidirectional microphone, or an array thereof, may be integrated in the video camera 134 and/or at the mobile communication device 133 (or additionally or alternatively made available at a separate location of the vehicle 132) and communicably coupled to the mobile communication device 133 and/or vehicular transceiver 136 for capturing audio and storing, processing, and/or transmitting the audio in a same or similar manner as set forth above with respect to the RSM 106.

The vehicle 132 may be a human-operable vehicle, or may be a self-driving vehicle operable under control of the mobile communication device 133 perhaps in cooperation with video camera 134 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link). In some embodiments, devices within the vehicle 132 may communicate with devices in other vehicles via a Vehicular to Vehicular (V2V) Network.

The vehicle 132 and/or transceiver 136, similar to the portable radio 104 and/or respective receivers, transmitters, or transceivers thereof, may include a location (and/or orientation) determination device integrated with or separately disposed in the mobile communication device 133 and/or transceiver 136 for determining (and storing and/or transmitting) a location (and/or orientation) of the vehicle 132.

In some embodiments, instead of a vehicle 132, a land, air, or water-based drone with the same or similar audio and/or video and communications capabilities and the same or similar self-navigating capabilities as set forth above may be disposed, and may similarly communicate with the user's 102 PAN and/or with the infrastructure RAN 152 to support the user 102 in the field.

The VAN may communicatively couple with the PAN disclosed above when the VAN and the PAN come within wireless transmission range of one another, perhaps after an authentication takes place there between. In some embodiments, one of the VAN and the PAN may provide infrastructure communications to the other, depending on the situation and the types of devices in the VAN and/or PAN and may provide interoperability and communication links between devices (such as video cameras) and sensors within the VAN and PAN.

Although the RSM 106, the laptop 114, and the vehicle 132 are illustrated in FIG. 1 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, other types of body worn cameras such as head-mounted cameras, other types of vehicular cameras such as roof-mounted cameras, drone cameras, or other types of audio and/or video recording devices accessible via a wired or wireless network interface same or similar to that disclosed herein.

In some embodiments, one or more of the user 102, the vehicle 132, the portable radio 104, the RSM video capture device 106, and any other device in FIG. 1 may be equipped with an environmental sensor such as a chemical, biological, radiological, nuclear, or explosive (CBRNE) sensor. Measurements made by the CBRNE sensor may be stored locally or transmitted via a transmitter or transceiver to other communication devices and/or to the infrastructure RAN 152.

Infrastructure RAN 152 is a radio access network that provides for radio communication links to be arranged within the network between a plurality of communication devices. Such communication devices may be portable, mobile, or stationary and may include any one or more of the communication devices illustrated in FIG. 1, among other possibilities. At least one other terminal, for example used in conjunction with the communication devices, may be a fixed terminal, for example a base station, eNodeB, repeater, and/or access point. Such a RAN typically includes a system infrastructure that generally includes a network of various fixed terminals, which are in direct radio communication with the communication devices. Each of the fixed terminals operating in the RAN 152 may have one or more transceivers which may, for example, serve communication devices in a given region or area, known as a ‘cell’ or ‘site’, by radio frequency (RF) communication. The communication devices that are in direct communication with a particular fixed terminal are said to be served by the fixed terminal. In one example, all radio communications to and from each communication device within the RAN 152 are made via respective serving fixed terminals. Sites of neighboring fixed terminals may be offset from one another and may provide corresponding non-overlapping or partially or fully overlapping RF coverage areas.

Infrastructure RAN 152 may operate according to an industry standard wireless access technology such as, for example, an LTE, LTE-Advance, or 5G technology over which an OMA-PoC, a VoIP, an LTE Direct or LTE Device to Device, or a PoIP application may be implemented. Additionally or alternatively, infrastructure RAN 152 may implement a wireless local area network (WLAN) technology such as Wi-Fi perhaps operating in accordance with an IEEE 802.11 standard (for example, 802.11a, 802.11b, 802.11g) or such as a WiMAX perhaps operating in accordance with an IEEE 802.16 standard.

Infrastructure RAN 152 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-POC, in particular and as one example of an infrastructure broadband wireless application, enables familiar PTT and “instant on” features of traditional half duplex communication devices, but uses communication devices operating over modern broadband telecommunications networks. Using PoC, wireless communication devices such as mobile telephones and notebook computers can function as PTT half-duplex communication devices for transmitting and receiving. Other types of PTT models and multimedia call models (MMCMs) are also available.

Floor control in an OMA-POC session is generally maintained by a PTT server (also referred to as a talk group server) that controls communications between two or more wireless communication devices. When a user of one of the communication devices keys a PTT button, a request for permission to speak in the OMA-POC session is transmitted from the user's communication device to the PTT server using, for example, a real-time transport protocol (RTP) message. If no other users are currently speaking in the PoC session, an acceptance message is transmitted back to the user's communication device and the user may then speak into a microphone of the communication device. Using standard compression/decompression (codec) techniques, the user's voice is digitized and transmitted using discrete auditory data packets (for example, together which form an auditory data stream over time), such as according to RTP and internet protocols (IP), to the PTT server. The PTT server then transmits the auditory data packets to other users of the PoC session (for example, to other communication devices in the group of communication devices or talkgroup to which the user is subscribed), using for example, one or more of a unicast, point to multipoint, or broadcast communication technique.

Infrastructure narrowband LMR wireless systems, on the other hand, operate in either a conventional or trunked configuration. In either configuration, a plurality of communication devices is partitioned into separate groups of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some embodiments, group IDs may be present in the group data to distinguish between groups using the same shared frequency).

In contrast, a trunked radio system and its communication devices use a pool of traffic channels for virtually an unlimited number of groups of communication devices (for example, talkgroups). Thus, all groups are served by all channels. The trunked radio system works to take advantage of the probability that not all groups need a traffic channel for communication at the same time. When a member of a group requests a call on a control or rest channel on which all of the communication devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the communication devices were idling to a traffic channel for the call, and instruct all communication devices that are not participating in the new call to move to a newly assigned control or rest channel selected from the pool of available channels. With a given number of channels, a much greater number of groups may be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (for example, communication devices) could be provisioned in the network by the user or an agent, and then provided some form of group identity or identifier, for example. Then, at a future time, an originating user in a group may cause some signaling to be transmitted indicating that he or she wishes to establish a communication session (for example, group call) with each of the pre-designated participants in the defined group. In another example, communication devices may dynamically affiliate with a group (and also disassociate with the group) perhaps based on user input, and the switching and/or radio network may track group membership and route new group calls according to the current group membership.

In some instances, broadband and narrowband systems may be interfaced via a middleware system that translates between a narrowband PTT standard protocol (such as P25) and a broadband PTT standard protocol or application (such as OMA-PoC). Such intermediate middleware may include a middleware server for performing the translations and may be disposed in the cloud, disposed in a dedicated on-premises location for a client wishing to use both technologies, or disposed at a public carrier supporting one or both technologies. For example, and with respect to FIG. 1, such a middleware server may be disposed in infrastructure RAN 152 at infrastructure controller 156 or at a separate cloud computing cluster 162 communicably coupled to infrastructure controller 156 via internet protocol (IP) network 160, among other possibilities.

The infrastructure RAN 152 is illustrated in FIG. 1 as providing coverage for the portable radio 104, RSM video capture device 106, laptop 114, smart glasses 116, and/or vehicle transceiver 136 via a single fixed terminal 154 coupled to a single infrastructure controller 156 (for example, a radio controller, call controller, PTT server, zone controller, MME, BSC, MSC, site controller, Push-to-Talk controller, or other network device) and including the dispatch console 158 operated by a dispatcher. In other embodiments, additional fixed terminals and additional controllers may be disposed to support a larger geographic footprint and/or a larger number of mobile devices.

The infrastructure controller 156 illustrated in FIG. 1, or some other back-end infrastructure device or combination of back-end infrastructure devices existing on-premises or in the remote cloud computing cluster 162 accessible via the IP network 160 (such as the Internet), may additionally or alternatively operate as a back-end electronic digital assistant, a back-end audio and/or video processing device, and/or a remote cloud-based storage device consistent with the remainder of this disclosure.

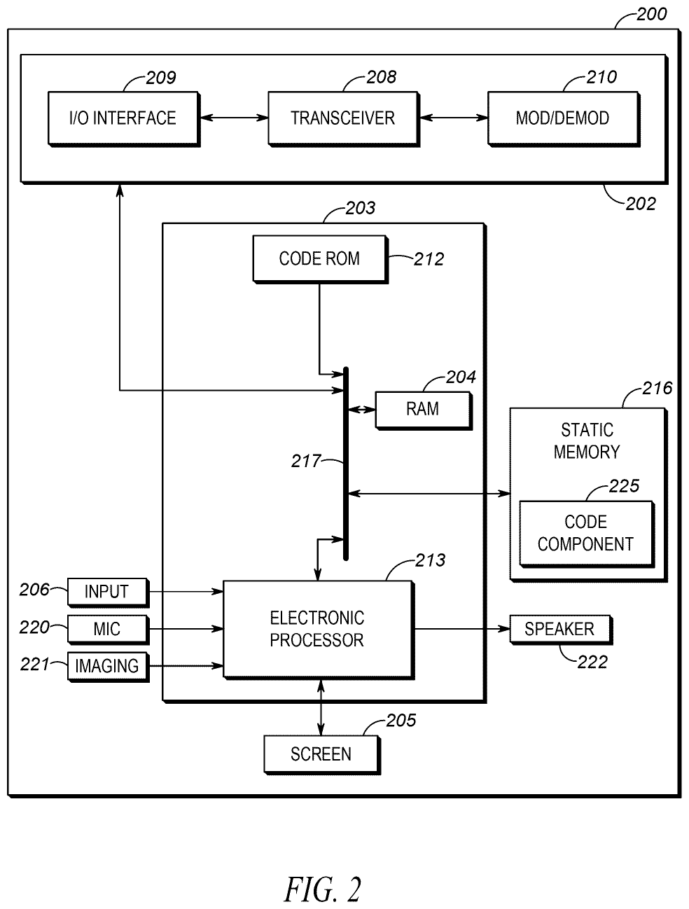

The IP network 160 may comprise one or more routers, switches, LANs, WLANs, WANs, access points, or other network infrastructure, including but not limited to, the public Internet. The cloud computing cluster 162 may be comprised of a plurality of computing devices, such as the one set forth in FIG. 2, one or more of which may be executing none, all, or a portion of an electronic digital assistant service, sequentially or in parallel, across the one or more computing devices. The one or more computing devices comprising the cloud computing cluster 162 may be geographically co-located or may be separated by inches, meters, or miles, and inter-connected via electronic and/or optical interconnects. Although not shown in FIG. 1, one or more proxy servers or load balancing servers may control which one or more computing devices perform any part or all of the electronic digital assistant service.

As shown in FIG. 1, database(s) 164 may be accessible via the IP network 160 and/or the cloud computing cluster 162. As shown in FIG. 1, the databases 164 are communicatively coupled with the infrastructure RAN 152 to allow the communication devices (for example, the portable radio 104, the RSM video capture device 106, the laptop 114, and the mobile communication device 133) to communicate with and retrieve data from the databases 164 via infrastructure controller 156 and IP network 160. In some embodiments, the databases 164 are commercial cloud-based storage devices. In some embodiments, the databases 164 are housed on suitable on-premises database servers. The database(s) may include databases such as a long-term video storage database, a historical or forecasted weather database, an offender database perhaps including facial recognition images to match against, a cartographic database of streets and elevations, a traffic database of historical or current traffic conditions, incident database including data such as incident assignment and timeline of incidents, or other types of databases. Databases 164 may further include all or a portion of the databases described herein as being provided at the infrastructure controller 156. In some embodiments, the databases 164 may be maintained by third parties (for example, the National Weather Service or a Department of Transportation, respectively). The databases 164 of FIG. 1 are merely examples. In some embodiments, the system 100 additionally or alternatively includes other databases that store different information. In some embodiments, the databases 164 and/or additional or other databases are integrated with, or internal to, the infrastructure controller 156.

Finally, although FIG. 1 describes a communication system 100 generally as a public safety communication system that includes a user 102 generally described as a police officer and a vehicle 132 generally described as a police cruiser, in other embodiments, the communication system 100 may additionally or alternatively be a retail communication system including a user 102 that may be an employee of a retailer and a vehicle 132 that may be a vehicle for use by the user 102 in furtherance of the employee's retail duties (for example, a shuttle or self-balancing scooter). In other embodiments, the communication system 100 may additionally or alternatively be a warehouse communication system including a user 102 that may be an employee of a warehouse and a vehicle 132 that may be a vehicle for use by the user 102 in furtherance of the employee's retail duties (for example, a forklift). In still further embodiments, the communication system 100 may additionally or alternatively be a private security communication system including a user 102 that may be an employee of a private security company and a vehicle 132 that may be a vehicle for use by the user 102 in furtherance of the private security employee's duties (for example, a private security vehicle or motorcycle). In even further embodiments, the communication system 100 may additionally or alternatively be a medical communication system including a user 102 that may be a doctor or nurse of a hospital and a vehicle 132 that may be a vehicle for use by the user 102 in furtherance of the doctor or nurse's duties (for example, a medical gurney or ambulance). In still another example embodiment, the communication system 100 may additionally or alternatively be a heavy machinery communication system including a user 102 that may be a miner, driller, or extractor at a mine, oil field, or precious metal or gem field and a vehicle 132 that may be a vehicle for use by the user 102 in furtherance of the miner, driller, or extractor's duties (for example, an excavator, bulldozer, crane, front loader). Other possibilities exist as well.

FIG. 2 sets forth a schematic diagram that illustrates a communication device 200 according to some embodiments of the present disclosure. The communication device 200 may be, for example, embodied in the portable radio 104, the RSM video capture device 106, the laptop 114, the mobile communication device 133, the infrastructure controller 156, the dispatch console 158, one or more computing devices in the cloud computing cluster 162, or some other communication device not illustrated in FIG. 1, and/or may be a distributed communication device across two or more of the foregoing (or multiple of a same type of one of the foregoing) and linked via a wired and/or wireless communication link(s). In some embodiments, the communication device 200 (for example, the portable radio 104) may be communicatively coupled to other devices such as the sensor-enabled holster 118 as described above. In such embodiments, the combination of the portable radio 104 and the sensor-enabled holster 118 may be considered a single communication device 200.

While FIG. 2 represents the communication devices 200 described above with respect to FIG. 1, depending on the type of the communication device, the communication device 200 may include fewer or additional components in configurations different from that illustrated in FIG. 2. For example, in some embodiments, the communication device 200 acting as the infrastructure controller 156 may not include one or more of the screen 205, microphone 220, imaging device 221, and speaker 222. As another example, in some embodiments, the communication device 200 acting as the portable radio 104 of the RSM video capture device 106 may further include a location determination device (for example, a global positioning system (GPS) receiver) as explained above. Other combinations are possible as well.

As shown in FIG. 2, the communication device 200 includes a communications unit 202 coupled to a common data and address bus 217 of a processing unit 203. The communication device 200 may also include one or more input devices (for example, keypad, pointing device, touch-sensitive surface, button, a microphone 220, an imaging device 221, and/or another input device 206) and an electronic display screen 205 (which, in some embodiments, may be a touch screen and thus also acts as an input device), each coupled to be in communication with the processing unit 203.

The microphone 220 may be present for capturing audio from a user and/or other environmental or background audio that is further processed by processing unit 203 in accordance with the remainder of this disclosure and/or is transmitted as voice or audio stream data, or as acoustical environment indications, by communications unit 202 to other portable radios and/or other communication devices. The imaging device 221 may provide video (still or moving images) of an area in a field of view of the communication device 200 for further processing by the processing unit 203 and/or for further transmission by the communications unit 202. A speaker 222 may be present for reproducing audio that is decoded from voice or audio streams of calls received via the communications unit 202 from other portable radios, from digital audio stored at the communication device 200, from other ad-hoc or direct mode devices, and/or from an infrastructure RAN device, or may playback alert tones or other types of pre-recorded audio.

The processing unit 203 may include a code Read Only Memory (ROM) 212 coupled to the common data and address bus 217 for storing data for initializing system components. The processing unit 203 may further include an electronic processor 213 (for example, a microprocessor or another electronic device) coupled, by the common data and address bus 217, to a Random Access Memory (RAM) 204 and a static memory 216.

The communications unit 202 may include one or more wired and/or wireless input/output (I/O) interfaces 209 that are configurable to communicate with other communication devices, such as the portable radio 104, the laptop 114, the wireless RAN 152, and/or the mobile communication device 133. For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

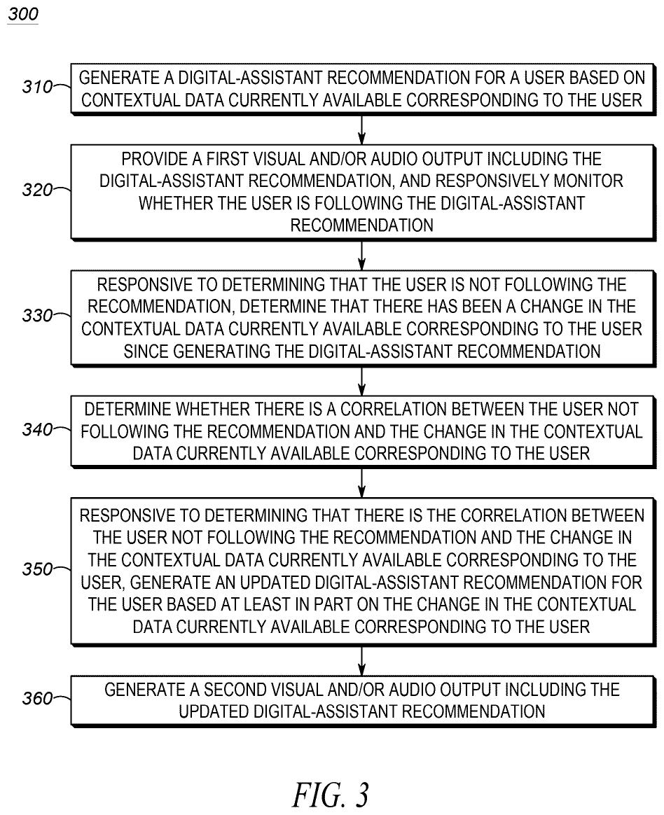

The electronic processor 213 has ports for coupling to the display screen 205, the microphone 220, the imaging device 221, the other input device 206, and/or the speaker 222. Static memory 216 may store operating code 225 for the electronic processor 213 that, when executed, performs one or more of the steps set forth in FIGS. 3-7 and the accompanying text. The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like.

In some embodiments, an individual component and/or a combination of individual components of the system 100 shown in FIG. 1 and/or components of the communication device 200 shown in FIG. 2 may be referred to as an electronic computing device that implements an electronic digital assistant as mentioned above. For example, the electronic computing device may be a single electronic processor (for example, the electronic processor 213 of the portable radio 104). In other embodiments, the electronic computing device includes multiple electronic processors distributed remotely from each other. For example, the electronic computing device may be implemented on a combination of at least two of the electronic processor 213 of the portable radio 104, the electronic processor 213 of the infrastructure controller 156, and the electronic processor 213 of a back-end device in the cloud computing cluster 162 accessible via the IP network 160.

In one embodiment, to use the electronic digital assistant implemented by the electronic computing device, the user 102 may provide, for example, an audio query that is received by the microphone 220 of the communication device 200. In accordance with some embodiments, the audio query received at the microphone is further transmitted as audio communications on a talk group channel for receipt by other users in a talk group. The electronic computing device receives signals representative of the audio query (directly from the microphone 220 or through monitoring audio communications on the talk group channel) and analyzes the signals to determine the intent and/or content of the audio query. For example, the electronic computing device may include a natural language processing (NLP) engine configured to determine the intent and/or content of the audio query. The electronic computing device may also be configured to determine a response to the audio query (for example, by retrieving stored data or by requesting data from a database such as the databases 164) and provide the response to an output device of the communication device 200 (for example, one or more of the speaker 222 via a generated audio response and the screen 205 via a generated text-based response). In other words, one or more of the communication device 200, embodied in one or more of the communication devices of FIG. 1, such as the portable radio 104, the infrastructure controller 156, and/or cloud computing cluster 162 may include a natural language processing engine to analyze audio queries received from the communication device 200 and provide responses to the audio queries in the form of audio data, image data, or text data. In accordance with some embodiments, the electronic digital assistant is also added to a talk group (for example, talk group) as a talk group member to monitor communications (as well as transmit communications) between communication devices 200 that are members of the talk group. In some of these embodiments, the user 102 may use the imaging device 221 to capture an image or video of an area and press a hard or soft key to send the image or video to the electronic computing device to, for example, allow the electronic computing device to identify an object in the image or video.

The electronic computing device may also be configured to determine a response to a text query. For example, the user 102 may submit a text query to the electronic computing device by typing the text query into a hard keyboard input device or a soft keyboard input provided on the screen 205 of the communication device 200. The text query is similarly processed by the electronic computing device using a natural language processing (NLP) engine that is configured to determine the intent and/or content of the text query.

In accordance with embodiments, the response generated by the electronic digital assistant may include one or more digital-assistant recommendations in relation to a task currently being assigned to or being performed by the user 102. In some embodiments, the electronic computing device may proactively (i.e., without receiving an explicit query from the user 102) generate a response when the electronic computing device determines that the user will benefit from digital-assistant recommendations based on contextual data currently available corresponding to the user 102.

FIG. 3 illustrates a flow chart diagram of a process 300 performed by the electronic computing device for updating a digital-assistant recommendation in response to a user not following the recommendation. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. The electronic computing device may execute process 300 via an electronic processor, for example, processor 213 shown in FIG. 2.

The electronic computing device may execute the process 300 at power-on, at some predetermined periodic time period thereafter, in response to a trigger raised locally at the electronic computing device via an internal process or via an input interface (e.g., in response to a text or audio query received from a user 102) or in response to a trigger (e.g., assignment of one or more incident-response tasks to a user 102) from an external device (e.g., dispatch console 158 operated by a dispatcher) to which the electronic computing device is communicably coupled, among other possibilities.

The process 300 of FIG. 3 need not be performed in the exact sequence as shown and likewise various blocks may be performed in different order or alternatively in parallel rather than in sequence. The process 300 may be implemented on variations of the system 100 of FIG. 1 as well.

At block 310, the electronic computing device generates a digital-assistant recommendation for a user (e.g., user 102) based on contextual data currently available corresponding to the user. In accordance with embodiments, the electronic digital assistant implemented by the electronic computing device may provide the user with digital-assistant recommendations in an automated (e.g., without further user input) or semi-automated (e.g., with some further user input) fashion by processing contextual data currently available corresponding to the user. The digital-assistant recommendations provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers (e.g., incident assignment, joining of a talkgroup, arriving at an incident location, user beginning to operate a tool or equipment etc.,) in which the electronic digital assistant may proactively provide such digital-assistant recommendations to the user absent any explicit request from the user.

The contextual data refers to any data that could be used to generate recommendations that would be useful for the user in executing one or more tasks currently assigned to or being executed by the user. The contextual data may also include data that is stored in the database 164. For example, the contextual data currently available corresponding to the user may include one or more of: an incident (e.g., computer aided dispatch (CAD) identifier (ID)) assigned to the user; type and/or severity of the incident assigned to the user; an incident-specific response task (e.g., spraying water in response to a fire incident, interviewing a witness, pursuing a fleeing suspect etc.,) assigned to and/or currently being executed by the user; current status of the incident; current user location, an agency (e.g., police, medical, firefighter agencies) to which the user is affiliated; rank, experience, role, skill level, or knowledge level (e.g., about an equipment or tool used by the user while responding to an incident) of the user; incident-response resources such as tools, equipment, vehicles, communication infrastructure, medicines, and the like that are accessible to or otherwise in possession by the user; conversations (e.g., current or historical talk-group conversations associated with the user) or user query (e.g., contextual data included as part of an audio or text query received from the user) available corresponding to the user; physical and environmental conditions (e.g., weather, temperature, wind speed, wind direction, water direction, water level, presence of chemical, biological, radiological, nuclear, or explosive substances etc.,) surrounding the user; user activity including user movement pattern, user behavior, user health etc., and the like. In accordance with some embodiments, the electronic computing device may obtain contextual data corresponding to the user from a combination of data sources that are available for capturing data corresponding to the user. For example, the data sources may include, but not limited to, communication device(s) (e.g., radio 104, mobile communication device 133, laptop 114, smart glass 116 etc.,) operated by the user, sensor devices (e.g., biometric sensor wristband 120, accelerometer, heart rate sensor, breathing rate sensor, body temperature sensor, sensor-enabled holster 118, environmental sensor including chemical, biological, radiological, nuclear, or explosive sensor) dispatch console 158, databases 164, and other data sources that are accessible to the electronic computing device.

As an example, when a firefighter is assigned to respond to a fire incident at a building, the electronic computing device may generate a digital-assistant recommendation based on contextual data currently available corresponding to the firefighter. For example, the contextual data currently available corresponding to the firefighter may indicate that the firefighter is assigned to the fire incident, for example, based on information received from the dispatch console 158. The contextual data may also further identify that the firefighter has arrived at the incident location (i.e., building) and the firefighter is assigned a task to operate the firehose and extinguish fire at the building. The contextual data currently available corresponding to the user may also include environmental conditions (e.g., wind speed, direction etc.,) surrounding the firefighter as obtained from one or more sensors (e.g., wind sensors) accessible to the electronic computing device. Based on the contextual data currently available corresponding to the firefighter, i.e., nature of the task assigned to the firefighter and environmental conditions (i.e., wind speed, direction etc.,), the electronic computing device generates a digital-assistant recommendation for the firefighter. The digital-assistant recommendation may include a procedure to be followed by the firefighter in executing a task assigned to the firefighter. For example, the procedure may include one or more instructions for the firefighter to operate the firehose and further spray water towards a particular direction in order to effectively extinguish fire at the building.

At block 320, the electronic computing device provides a first visual and/or audio output including the digital-assistant recommendation generated at block 310, and responsively monitors whether the user is following the digital-assistant recommendation. The digital-assistant recommendations may take the form of text, image, video, or audio. The electronic computing device may provide the first visual and/or audio output on a corresponding visual and/or audio output device. For example, the visual and/or audio output device may include a display component (e.g., display 205) and/or a speaker component (e.g., speaker 222) implemented on one or more devices (e.g., portable radio 104, laptop 114, mobile communication device 133, smart glass 166 etc.,) associated with the user. The digital-assistant recommendations in the form of text, image, or video may be rendered via the display component of the visual and/or audio output device. The digital-assistant recommendations in the form of audio are played back via the speaker component of the visual and/or audio output device.

In accordance with embodiments, in response to providing the digital-assistant recommendation to the visual and/or audio output device operated by the user, the electronic digital assistant implemented by the electronic computing device proactively (i.e., without further user input) monitors if the user is following or not following the digital-assistant recommendation provided by the electronic computing device. The electronic computing device uses one or more visual and/or non-visual sensors to monitor user actions (or inactions) that may indicate whether or not the user is following the digital-assistant recommendations. For example, the visual sensors may include cameras including surveillance cameras, body-worn cameras, or drone cameras that are capable of capturing images or videos corresponding to the user. In this example, the electronic computing device may use a video analytics engine for analyzing videos or images captured corresponding to the user. The video analytics engine may include one or more classifiers that may be particularly trained to recognize the activities of the user as well as recognize objects with which the user interacts, for example, to perform one or more tasks assigned to the user. As an example, the digital-assistant recommendation may include an instruction for a firefighter to spray water in a specific direction to extinguish fire at a building. In this example, the video analytics engine may process images or videos captured corresponding to the user to determine if the user is spraying the water in the direction specified in the digital-assistant recommendation. For example, when the video analytics engine processes images or videos captured corresponding to the firefighter and extracts video analytics data indicating that the firefighter has activated the firehose (e.g., by turning the firehose nozzle into an open position) and sprayed water towards a direction instructed in the digital-assistant recommendation, the electronic digital assistant implemented by the electronic computing device may make a determination that the firefighter is following the digital-assistant recommendation. On the other hand, when the video analytics engine processes the images or videos captured corresponding to the firefighter and extracts video analytics data indicating that either the fire fighter has not taken any action (e.g., firehose has not been activated or the firehose nozzle remains in a closed position) for a predefined duration of time since providing the digital-assistant recommendation or the firefighter has performed a different action that does not follow (e.g., firefighter has sprayed water in a direction different from the one specified in the instruction included in the digital-assistant recommendation) the digital-assistant recommendation, the electronic computing device may make a determination that the firefighter is not following the digital-assistant recommendation.

In accordance with some embodiments, when the electronic computing device determines that the user is following the digital-assistant recommendation, the electronic computing device waits for further user input (e.g., audio query) or until the user completes execution of the task currently assigned to the user in order to provide additional digital-assistant recommendations to the user.

When the electronic computing device determines that the user is not following the recommendation, the electronic computing device proceeds to block 330 to determine whether there has been a change in the contextual data currently available corresponding to the user since generating the digital-assistant recommendation for the user. In accordance with some embodiments, as soon as the electronic computing device determines that the user is not following the recommendation, the electronic computing device transmits an electronic request to one or more data sources to capture and provide updated contextual data corresponding to the user. The electronic computing device may transmit a request to one or more data sources previously accessed by the electronic computing device in generating the digital-assistant recommendation for the user at block 310. Based on the information obtained from the data sources, the electronic computing device determines if there has been a change in the contextual data currently available corresponding to the user since the digital-assistant recommendation was generated at block 310. For instance, in the firefighter example described above, the electronic computing device may transmit a request to the dispatch console to determine if there has been a change in the task (e.g., spray water) assigned to the firefighter. The electronic computing device may also obtain sensor data from one or more wind sensors indicating if there has been a change in one or more of the wind speed or direction near the incident location. In accordance with embodiments, the electronic computing device uses the updated contextual data to determine if the most likely explanation for the user not following the digital-assistant recommendation is the change in the contextual data since generating the previous digital-assistant recommendation.

At block 340, the electronic computing device determines whether there is a correlation between the user not following the recommendation and the change in the contextual data currently available corresponding to the user. It may be noted that not all changes in contextual data currently available corresponding to the user may have an effect on the user's decision (and the corresponding user action or inaction) to follow or not follow the recommendation provided by the digital assistant. Accordingly, the electronic computing device analyzes the change in the contextual data to determine if the most likely explanation for the user not following recommendation is due to the change in the contextual data. In accordance with some embodiments, the electronic computing device obtains contextual data corresponding to the user for a number of different contextual parameters. For example, the contextual parameter may include a task assigned to the user for responding to an incident, user's health status, current state of operation of an equipment, tool, or vehicle used by the user, environmental data captured corresponding to the incident location, and the like. In one embodiment, the electronic computing device first identifies each contextual parameter that was used as an input in generating the digital-assistant recommendation at block 310. The electronic computing device then determines whether there has been a change in contextual data associated with at least one such contextual parameter that was used as the input in generating the digital-assistant recommendation. In this embodiment, when the electronic computing device determines that there has been change in contextual data associated with at least one such contextual parameter that was used as the input in generating the digital-assistant recommendation, the electronic computing device also determines that there is a correlation between the user not following the recommendation and the change in the contextual data currently available corresponding to the user. In one embodiment, in order to determine if there is a correlation between the user not following the digital-assistant recommendation and the change in contextual data currently available corresponding to the user, the electronic computing device may prioritize one contextual parameter over another contextual parameter based on the type of task being executed by the user. For example, in the firefighter example, the firefighter is assigned to spray water from the firehose to extinguish fires at the building. In this case, contextual parameters such as a current operational state of the firehose and environmental conditions surrounding the firefighter may be prioritized over other contextual parameters (that may not be relevant for the task currently assigned to the firefighter) in determining if there is a correlation between the user not following the recommendation and the change in contextual data. Additionally or alternatively, the electronic computing device also determines whether the change in contextual data available corresponding to the user exceeds a threshold level. For instance, in the firefighter example described above, assume the electronic computing device provided a digital-assistant recommendation indicating a particular direction for spraying water based on sensor data obtained from wind sensors indicating a wind speed of 4 mph. Responsive to the firefighter not following the digital-assistant recommendation, the electronic computing device obtains updated sensor data from wind sensors at the firefighter's location indicating a current wind speed of 28 mph. In this example, further assume the threshold level is set at 12 mph. In this case, since the wind speed of 28 mph exceeds the threshold level of 12 mph, the electronic computing device determines that there is a correlation between the firefighter not following the water spraying direction specified in the digital-assistant recommendation provided for the firefighter and the change in the contextual data (i.e., change of wind speed from 4 mph to 28 mph) currently available corresponding to the user.

When the electronic computing device determines that there has been no change in contextual data (or alternatively any change in contextual change does not exceed a threshold level) associated with any of the contextual parameters used as input in generating the digital-assistant recommendation, the electronic computing device determines that there is no correlation between the user not following the recommendation and the change in the contextual data currently available corresponding to the user. For instance, in the firefighter example, the electronic computing device may determine that any change in contextual data associated with contextual parameters such as task currently assigned to the firefighter, health status of the firefighter, current operational state of the firehose, or environmental conditions such as wind speed or direction near the fire incident location, does not exceed a threshold level. Accordingly, in this case, the electronic computing device determines that there is no correlation between the firefighter not following the digital-assistant recommendation and the change in contextual data currently available corresponding to the firefighter. In accordance with some embodiments, when the electronic computing device determines that there is no correlation between the user not following the recommendation and the change in contextual data currently available corresponding to the user, the electronic computing device generates a digital-assistant prompt reminding the user to follow the digital-assistant recommendation previously provided to the user at block 320. The digital-assistant prompt may be provided in the form of visual and/or audio output (e.g., text, audio, image, or video) via a corresponding visual and/or audio output device associated with the user.

At block 350, when the electronic computing device determines that there is a correlation between the user not following the recommendation and the change in the contextual data currently available corresponding to the user, the electronic computing device generates a digital-assistant recommendation for the user based at least in part on the change in the contextual data currently available corresponding to the user. For instance, in the firefighter example, when the electronic computing device determines that there is a correlation between the firefighter not following the digital-assistant recommendation of spraying water in a particular direction specified by the digital-assistant recommendation and change in contextual data such as wind speed or direction near the firefighter location, the electronic computing device generates an updated digital-assistant recommendation by accounting the change in the wind speed or direction near the firefighter location. For example, the updated digital-assistant recommendation may include a recommendation for the firefighter to spray water in a direction different from the one specified in the digital-assistant recommendation previously provided to the user at block 320.

At block 360, the electronic computing device provides a second visual and/or audio output including the updated digital-assistant recommendation. The update digital-assistant recommendation may include a different procedure (i.e., a procedure different from the procedure included in the digital-assistant recommendation provided to the user at block 320) to be followed by the firefighter in executing a task assigned to the firefighter. For example, the procedure may include one or more instructions for the firefighter to spray water in a direction different from the one specified in the digital-assistant recommendation previously provided to the user. The updated digital-assistant recommendation may similarly take the form of text, image, video, or audio. The electronic computing device may provide the second visual and/or audio output on a corresponding visual and/or audio output device. For example, the visual and/or audio output device may include a display component (e.g., display 205) and/or a speaker component (e.g., speaker 222) implemented on one or more devices (e.g., portable radio 104, laptop 114, mobile communication device 133, smart glass 166 etc.,) operated by the user. The updated digital-assistant recommendation in the form of text, image, or video may be rendered via the display component of the visual and/or audio output device. The updated digital-assistant recommendation in the form of audio is played back via the speaker component of the visual and/or audio output device. In one embodiment, the electronic computing device may visually or audibly highlight the updates or changes made to the updated digital-assistant recommendation in relation to the previously provided digital-assistant recommendation.

In accordance with some embodiments, each time after providing an updated digital-assistant recommendation, the electronic computing device repeats the execution of the process 300 described herein to monitor whether the user is following the updated digital-assistant recommendation and to further update digital-assistant recommendation in response to determining a correlation between the user not following the updated digital-assistant recommendation and a change in contextual data currently available corresponding to the user since generating the digital-assistant recommendation previously provided to the user.

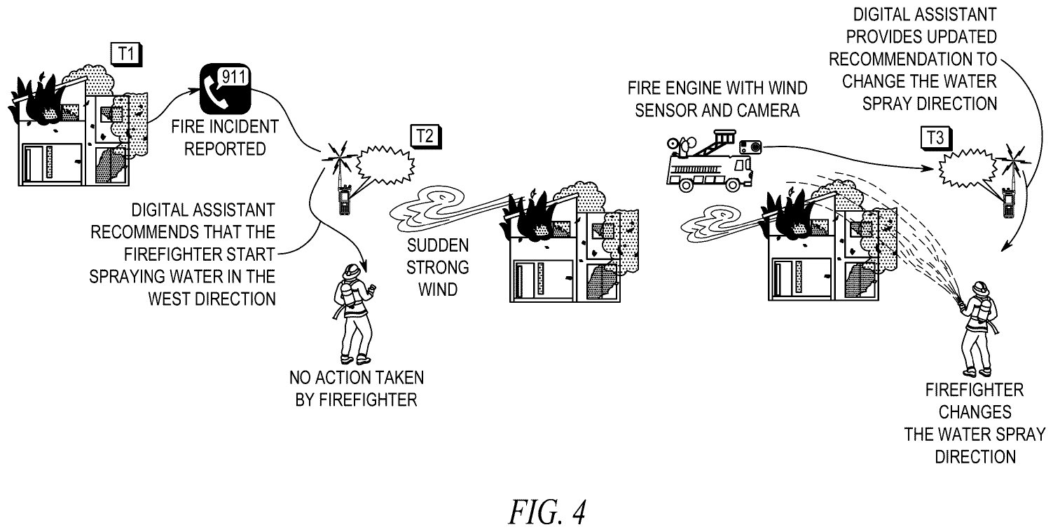

Now referring to FIG. 4, an example scenario 400 in which the process 300 described herein can be advantageously implemented to update a digital-assistant recommendation in response to a user not following the recommendation. In the example scenario 400, assume a 911 call was made to a public-safety answering point reporting a fire incident at a building. In response, further assume a firefighter was dispatched to respond to the fire incident. In accordance with embodiments described herein, an electronic computing device implementing a digital assistant receives information (e.g., from dispatch console 158 operated by a dispatcher) indicating that a firefighter has been dispatched to a location of the building. In response, at time ‘T1’, the electronic computing device obtains contextual data corresponding to the firefighter. The contextual data may include a current task assigned to the firefighter, for example, spray water to extinguish fires at the building, a current operational state of an equipment (e.g., firehose) available to the firefighter, and environmental conditions such as wind speed and direction near the building. In the example shown in FIG. 4, based on the contextual data available to the electronic computing device at time ‘T1’, the electronic computing device generates a digital-assistant recommendation recommending that the firefighter start spraying water in the west direction relative to the building. The digital-assistant recommendation may be provided as an audio output via a communication device operated by the firefighter. In accordance with the process 300 described herein, at time ‘T2’ i.e., after providing the digital-assistant recommendation, the electronic computing device proactively monitors whether the firefighter is following the digital-assistant recommendation i.e., has begun to spray water in the west direction specified in the recommendation. In one embodiment, in order to determine whether the firefighter is following the digital-assistant recommendation, the electronic computing device receives a video stream (e.g., from a vehicular camera mounted to a fire truck) captured corresponding to the user. The electronic computing device then processes the video stream using a video analytics engine to extract information related to user's action or inaction in response to providing the digital-assistant recommendation. If the user's action or inaction does not comply with one or more of the instructions included in the digital-assistant recommendation provided for the firefighter, then the electronic computing device determines that the user is not following the digital-assistant recommendation. Additionally or alternatively, the electronic computing device may also obtain a current operational state of an equipment such as the firehose associated with the firefighter to determine if the firefighter has begun to spray water as instructed in the digital-assistant recommendation. For example, the electronic computing device may determine that the firefighter is not following the recommendation based on information obtained from a firehose sensor indicating that the firefighter has not taken any action to turn the firehose nozzle into an open state.

In any case, when the electronic computing device determines that the firefighter is not following the digital-assistant recommendation, the electronic computing device determines whether there has been a change in contextual data available corresponding to the firefighter between time ‘T1’ and ‘T2’. For instance, in the example shown in FIG. 4, the electronic computing device obtains sensor data from wind sensor or camera deployed in the fire truck and further determines that the sensor data indicates an increase in wind speed (e.g., from 4 mph at time ‘T1’ to 24 mph at time ‘T2’) near the firefighter's location. Because the increase in wind speed exceeds a threshold level (e.g. 12 mph), the electronic computing device determines that there is a correlation between the firefighter not following the recommendation and the increase in wind speed. Accordingly, in this case, at time ‘T3’, the electronic computing device proactively (i.e., without receiving or processing any explicit input from the user between time ‘T1’ and ‘T2’) generates an updated digital-assistant recommendation recommending the firefighter to change the water spray direction on the basis of the change in contextual data (i.e., wind speed exceeding the threshold level) available corresponding to the firefighter.

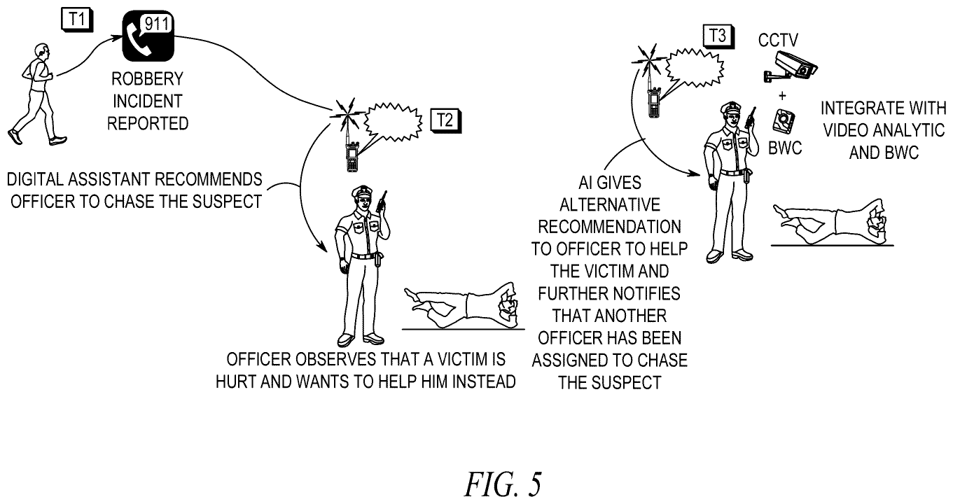

Now referring to FIG. 5, an example scenario 500 in which the process 300 described herein can be advantageously implemented to update a digital-assistant recommendation in response to a user not following the recommendation. In the example scenario 500, assume a 911 call was made to a public-safety answering point reporting a robbery incident. In response, an electronic computing device implementing a digital assistant receives information (e.g., from dispatch console) identifying a police officer who has been dispatched to respond to the robbery incident. In response, at time ‘T1’, the electronic computing device obtains contextual data corresponding to the police officer assigned to the incident. The contextual data may include a current location of the police officer and type of the incident being responded to by the officer. In the example shown in FIG. 5, based on the contextual data available to the electronic computing device at time ‘T1’, the electronic computing device generates and provides a digital-assistant recommendation recommending the officer to chase the suspect. The electronic computing device also further provides information indicating a possible direction in which the suspect is fleeing. The digital-assistant recommendation may be provided as an audio output via a communication device operated by the officer. In accordance with the process 300 described herein, at time ‘T2’ i.e., after providing the digital-assistant recommendation, the electronic computing device proactively monitors whether the officer is following the digital-assistant recommendation i.e., whether the officer is heading in the direction specified by the digital-assistant recommendation to chase the fleeing suspect. In one embodiment, in order to determine whether the officer is following the digital-assistant recommendation, the electronic computing device may track an activity (e.g., officer's orientation, direction, steps, acceleration, and/or speed) of the officer, for example, using movement sensors included in a biometric sensor wristband worn by the officer, and further determine whether the officer is chasing the suspect as recommended by the digital assistant. The electronic computing device may additionally or alternatively process video streams (e.g., captured by an officer's body-worn camera or a surveillance camera deployed near the officer's current location) to extract information related to the officer's activity. If the officer's activity (e.g., indicating no substantial movement or acceleration) does not comply with one or more of the instructions (i.e., to chase the suspect) included in the digital-assistant recommendation provided for the officer, then the electronic computing device determines that the officer is not following the digital-assistant recommendation. In the example shown in FIG. 5, the officer did not follow the digital-assistant recommendation because the officer observed an injured person at the incident location and wanted to help the person instead of chasing the suspect as recommended by the digital assistant. The initial digital-assistant recommendation for the officer to chase the suspect was generated by the electronic computing device absent any input regarding status of a victim at the incident location.

In any case, when the electronic computing device determines that the police officer is not following the digital-assistant recommendation, the electronic computing device determines that there has been a change in contextual data available corresponding to the officer between time ‘T1’ and ‘T2’. For instance, in the example shown in FIG. 5, the electronic computing device obtains information (e.g., based on images captured by the surveillance camera or the officer's body worn camera) indicating that the victim was injured during the incident. The electronic computing device also receives information (e.g., officer's radio) indicating the police officer is currently located at the incident location (i.e., same location as the victim). Based on the change in the contextual data available corresponding to the officer between time ‘T1’ and ‘T2’ i.e., the victim being injured during the robbery incident and officer's current location matching the incident location, the electronic computing device determines that there is a correlation between the officer not following the recommendation (i.e., intending to help the victim rather than chasing the suspect) and the change in the contextual data available corresponding to the officer. Accordingly, in this case, at time ‘T3’, the electronic computing proactively (i.e., without receiving or processing any explicit input from the user between time ‘T1’ and ‘T2’) generates an updated digital-assistant recommendation recommending the officer to not chase the suspect and instead help the victim. The updated digital-assistant recommendation may further include a notification for the officer indicating that another officer has been dispatched to chase the suspect.

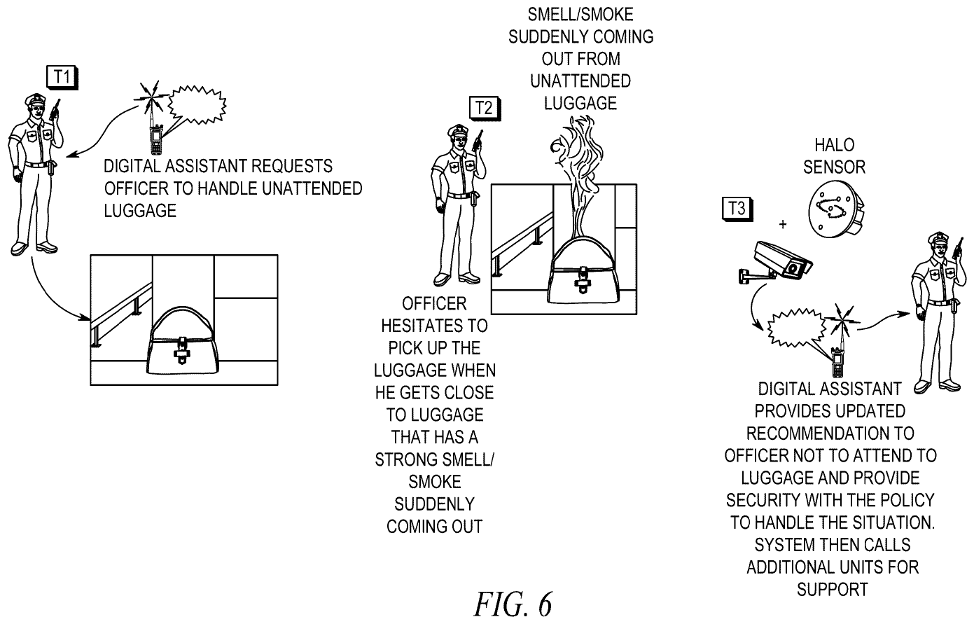

Now referring to FIG. 6, an example scenario 600 in which the process 300 described herein can be advantageously implemented to update a digital-assistant recommendation in response to a user not following the recommendation. In the example scenario 600, assume an electronic computing device implementing a digital assistant receives information regarding an unattended luggage at an airport. The electronic computing device identifies an airport security officer who is patrolling near the location where the unattended luggage is found. In response, at time ‘T1’, the electronic computing device generates a digital-assistant recommendation recommending the security officer to remove the unattended luggage in accordance with airport's security procedure. The digital-assistant recommendation may be provided as an audio output via a communication device operated by the security officer. In accordance with the process 300 described herein, at time ‘T2’ i.e., immediately after providing the digital-assistant recommendation, the electronic computing device monitors whether the officer is following the digital-assistant recommendation to remove the unattended luggage found in the airport. In one embodiment, in order to determine whether the officer is following the digital-assistant recommendation, the electronic computing device may process video streams (e.g., captured by the officer's body-worn camera or surveillance cameras deployed near the officer's location) to extract information related to the officer's activity. If the officer's inaction (e.g., indicating no interaction with the luggage) does not comply with one or more of the instructions (i.e., to remove the luggage) included in the digital-assistant recommendation provided for the officer, then the electronic computing device determines that the officer is not following the digital-assistant recommendation. In the example shown in FIG. 6, the officer did not follow the digital-assistant recommendation because the officer observed smoke coming out of the luggage. The initial digital-assistant recommendation for the officer to remove the unattended luggage was generated by the electronic computing device absent any input regarding the smoke emitting from the luggage.

In any case, when the electronic computing device determines that the security officer is not following the digital-assistant recommendation, the electronic computing device determines that there has been a change in contextual data available corresponding to the officer between time ‘T1’ and ‘T2’. For instance, in the example shown in FIG. 6, the electronic computing device obtains information (e.g., based on data obtained from smoke sensors or cameras deployed at the airport) indicating presence of smoke near the luggage. Based on the change in the contextual data available corresponding to the officer between time ‘T1’ and ‘T2’ i.e., presence of smoke near the luggage, the electronic computing device determines that there is a correlation between the officer not following the recommendation (i.e., hesitating to remove the unattended luggage) and the change in the contextual data available corresponding to the officer. Accordingly, in this case, at time ‘T3’, the electronic computing proactively (i.e., without receiving or processing any explicit input from the user between time ‘T1’ and ‘T2’) generates an updated digital-assistant recommendation recommending the officer not to remove the luggage and instead to secure the immediate area around the luggage. The updated digital-assistant recommendation may also include a notification for the officer indicating that additional units (e.g., officers specialized in detecting explosives) are being dispatched to handle the luggage.

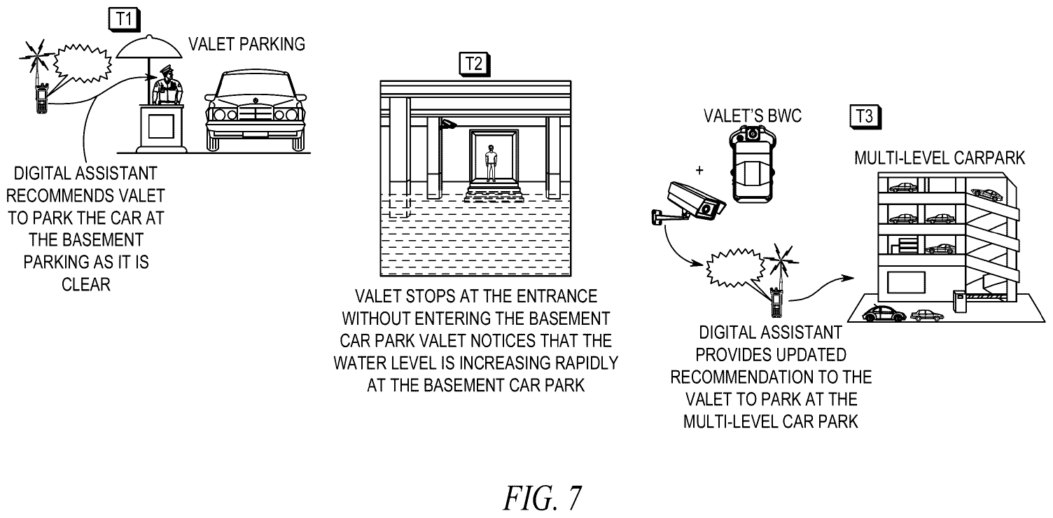

Now referring to FIG. 7, an example scenario 700 in which the process 300 described herein can be advantageously implemented to update a digital-assistant recommendation in response to a user not following the recommendation. In the example scenario 700, assume an electronic computing device implementing a digital assistant receives a query from a valet requesting a parking space for a vehicle. In response, at time ‘T1’, the electronic computing device identifies parking spaces available for valet parking and further generates a digital-assistant recommendation recommending the valet to park the vehicle at an identified basement parking space at the hotel. The digital-assistant recommendation may be provided as an audio output via a communication device operated by the valet. In accordance with the process 300 described herein, at time ‘T2’ i.e., immediately after providing the digital-assistant recommendation, the electronic computing device monitors whether the valet has parked the car at the basement parking space as identified in the digital-assistant recommendation. In one embodiment, in order to determine whether the valet officer is following the digital-assistant recommendation, the electronic computing device may process video streams (e.g., captured by surveillance cameras deployed at the hotel) to extract information related to valet's activity. If the valet's action does not comply with one or more of the instructions (i.e., to park the vehicle in the identified basement parking space) included in the digital-assistant recommendation provided for the valet, then the electronic computing device determines that the valet is not following the digital-assistant recommendation. In the example shown in FIG. 7, the valet did not follow the digital-assistant recommendation because the water level (possibly caused by a broken water pipe) at the basement made the identified basement parking space not suitable for parking. The initial digital-assistant recommendation for the valet to park the vehicle at the basement parking space was generated by the electronic computing device absent any input regarding the water level at the basement or the condition of the pipes at the basement.

In any case, when the electronic computing device determines that the valet is not following the digital-assistant recommendation, the electronic computing device determines that there has been a change in contextual data available corresponding to the valet between time ‘T1’ and ‘T2’. For instance, in the example shown in FIG. 7, the electronic computing device obtains information (e.g., based on sensor data obtained from IoT sensors such as water leak/level sensors) indicating water level at the basement exceeding a threshold level. Based on the change in the contextual data available corresponding to the valet between time ‘T1’ and ‘T2’ i.e., water level exceeding the threshold level, the electronic computing device determines that there is a correlation between the valet not following the recommendation (i.e., hesitating to park the vehicle at the identified basement parking space) and the change in the contextual data available corresponding to the valet. Accordingly, in this case, at time ‘T3’, the electronic computing proactively (i.e., without receiving or processing any explicit input from the valet between time ‘T1’ and ‘T2’) generates an updated digital-assistant recommendation recommending the valet not to park the vehicle at the identified basement parking space and to instead park the vehicle at an identified multi-level parking space.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of updating a digital-assistant recommendation in response to a user not following the recommendation, the method comprising:
generating, at an electronic computing device, a digital-assistant recommendation for a user based on contextual data currently available corresponding to the user;
providing, at the electronic computing device, via a visual and/or audio output device associated with the user, a first visual and/or audio output including the digital-assistant recommendation, and responsively monitoring whether the user is following the digital-assistant recommendation;
responsive to determining that the user is not following the recommendation, determining, at the electronic computing device, that there has been a change in the contextual data currently available corresponding to the user since generating the digital-assistant recommendation;
determining, at the electronic computing device, whether there is a correlation between the user not following the recommendation and the change in the contextual data currently available corresponding to the user;
responsive to determining that there is the correlation between the user not following the recommendation and the change in the contextual data currently available corresponding to the user, generating, at the electronic computing device, an updated digital-assistant recommendation for the user based at least in part on the change in the contextual data currently available corresponding to the user; and
providing, at the electronic computing device, via the visual and/or audio output device associated with the user, a second visual and/or audio output including the updated digital-assistant recommendation.

2. The method of claim 1, wherein generating the updated digital-assistant recommendation comprises:
generating the updated digital-assistant recommendation without receiving input from the user during a time period after generating the digital-assistant recommendation.

3. The method of claim 1, wherein generating the digital-assistant recommendation comprises:
determining that the user is assigned to respond to an incident;
identifying, based on the contextual data currently available corresponding to the user, a first procedure to be followed by the user in responding to the incident; and
including the first procedure to be followed by the user in the digital-assistant recommendation.

4. The method of claim 3, wherein generating the updated digital-assistant recommendation comprises:
identifying, based at least in part on the change in contextual data currently available corresponding to the user, a second procedure to be followed by the user in responding to the incident; and
including the second procedure to be followed by the user in the updated digital-assistant recommendation.

5. The method of claim 3, wherein the contextual data currently available corresponding to the user comprises environmental data captured corresponding to a location of the incident prior to generating the digital-assistant recommendation.

6. The method of claim 3, wherein the contextual data currently available corresponding to the user comprises a task currently assigned to the user for responding to the incident.

7. The method of claim 3, wherein the contextual data currently available corresponding to the user comprises health data captured corresponding to the user or another person associated with the incident.

8. The method of claim 3, wherein the contextual data currently available corresponding to the user comprises a current state of operation of an equipment, a vehicle, or a tool used by the user to respond to the incident.

9. The method of claim 1, further comprising:
responsive to determining that there is no correlation between the user not following the recommendation and the change in the contextual data currently available corresponding to the user, generating, at the electronic computing device, a digital-assistant prompt reminding the user to follow the digital-assistant recommendation previously provided to the user; and
providing, via the visual and/or audio output device associated with the user, a third visual and/or audio output including the digital-assistant prompt.

10. The method of claim 1, wherein determining whether there is a correlation between the user not following the recommendation and the change in the contextual data currently available corresponding to the user comprises:
determining that the change in the contextual data currently available corresponding to the user exceeds a threshold level.

11. The method of claim 1, wherein determining that the user is not following the recommendation comprises:
subsequent to providing the digital-assistant recommendation, receiving a video stream captured corresponding to the user;
processing the video stream using a video audio analytics engine to extract information related to user's action or inaction; and
determining that the user's action or inaction does not comply with one or more instructions included in the digital-assistant recommendation provided to the user.

12. An electronic computing device comprises:
an electronic processor; and
a visual and/or audio output device communicatively coupled to the electronic processor, the electronic processor configured to:
generate a digital-assistant recommendation for a user based on contextual data currently available corresponding to the user;
provide, via the visual and/or audio output device associated with the user, a first visual and/or audio output including the digital-assistant recommendation, and responsively monitor whether the user is following the digital-assistant recommendation;
responsive to determining that the user is not following the recommendation, determine that there has been a change in the contextual data currently available corresponding to the user since generating the digital-assistant recommendation;
determine whether there is a correlation between the user not following the recommendation and the change in the contextual data currently available corresponding to the user;
responsive to determining that there is the correlation between the user not following the recommendation and the change in the contextual data currently available corresponding to the user, generate an updated digital-assistant recommendation for the user based at least in part on the change in the contextual data currently available corresponding to the user; and
provide, via the visual and/or audio output device associated with the user, a second visual and/or audio output including the updated digital-assistant recommendation.

13. The electronic computing device of claim 12, wherein the electronic processor is configured to generate the updated digital-assistant recommendation without receiving user input from the user during a time period after generating the digital-assistant recommendation.

14. The electronic computing device of claim 12, wherein the electronic processor is configured to:
determine that the user is assigned to respond to an incident;
identify, based on the contextual data currently available corresponding to the user, a first procedure to be followed by the user in responding to the incident; and
include the first procedure to be followed by the user in the digital-assistant recommendation.

15. The electronic computing device of claim 14, wherein the electronic processor is configured to:
identify, based at least in part on the change in contextual data currently available corresponding to the user, a second procedure to be followed by the user in responding to the incident; and
include the second procedure to be followed by the user in the updated digital-assistant recommendation.

16. The electronic computing device of claim 14, wherein the contextual data currently available corresponding to the user comprises environmental data captured corresponding to a location of the incident prior to generating the digital-assistant recommendation.

17. The electronic computing device of claim 14, wherein the contextual data currently available corresponding to the user comprises a task currently assigned to the user for responding to the incident.

18. The electronic computing device of claim 14, wherein the contextual data currently available corresponding to the user comprises a current state of operation of an equipment, a vehicle, or a tool used by the user to respond to the incident.

19. The electronic computing device of claim 12, wherein the electronic computing device is configured to determine that there is a correlation between the user not following the recommendation and the change in the contextual data currently available corresponding to the user when the change in the contextual data currently available corresponding to the user exceeds a threshold level.

20. The electronic computing device of claim 12, wherein the electronic computing device is configured to:
subsequent to providing the digital-assistant recommendation, receive a video stream captured corresponding to the user;
process the video stream using a video audio analytics engine to extract information related to user's action or inaction; and
determine that the user's action or inaction does not comply with one or more instructions included in the digital-assistant recommendation provided to the user.
